(19) United States
(12) Patent Application Publication
(10) Pub. No.: US 2008/0179457 A1
(43) Pub. Date: Jul. 31, 2008

(54) PASSENGER AIRCRAFT

(75) Inventor: Bernard Guering, Montrabe (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 11/775,882

(22) Filed: Jul. 11, 2007

(30) Foreign Application Priority Data
Jul. 12, 2006 (FR) 0606343

(51) Int. Cl. B64D 11/00

(52) U.S. Cl. 244/118.5

(57) ABSTRACT

The invention has as its purpose an aircraft for transport of passengers having a fuselage (1) comprising a pressurized level (2) in which there are laid out the passenger cabin (20) and a lower level forming a hold (3).

According to the invention, the cockpit (40) is positioned in an additional pressurized space (4) laid out below the main deck (10), at the level of the hold (3) and separated from the latter by a structure (41) withstanding possible impacts.

The invention has as its purpose a new configuration of an aircraft for transport of passengers.

In general, an aircraft for transport of passengers comprises a cockpit and a cabin for the passengers, laid out inside a fuselage divided into two levels by a floor forming a main deck that extends over the entire length of a main portion of the fuselage, respectively an upper level that is pressurized and air-conditioned and a lower level forming a hold for baggage and various loads transported.

The steady growth in air traffic, in particular for the transport of passengers, requires an increase in the transport capacity of aircraft which, however, must retain dimensions compatible with the accommodation potential of airports.

It therefore is helpful to make the best use of the possibilities for layout of the internal space of the fuselage, the dimensions of which remain limited.

In addition, for long distances, the comfort of the passengers must be enhanced, for example by giving them some possibility of moving about inside the aircraft and by planning relaxation areas.

Furthermore, it has become necessary to protect the crew, in particular the pilots, against acts of skyjacking. For that purpose, the cockpit can be isolated from the passenger cabin by a wall provided with a reinforced door, but this protection can prove to be insufficient.

The invention has as its purpose a new architecture of an aircraft for transport of passengers, making it possible to provide solutions to this set of problems and, moreover, offering multiple advantages.

It proposes an aircraft for transport of passengers comprising a cockpit and a cabin for the passengers inside a fuselage divided into two levels by a floor forming a main deck, respectively a pressurized upper level and a lower level forming a hold for the loads transported.

In accordance with the invention, the cockpit is positioned in a pressurized space laid out in front of the hold and at the same level as the latter, below the passenger cabin that extends over the entire length of the main deck, the said pressurized front space being closed toward the rear by a structure withstanding possible impacts coming from the hold.

In particularly advantageous manner, the hold being laid out on a lower floor, the front portion of the latter forms the floor of the cockpit. Preferably, the front end of this lower floor, at the tip of the aircraft, is slightly raised so as to impart a sufficient width to the cockpit, taking into account the pointed shape of the fuselage.

Likewise, the upper floor forming the main deck and on which the passenger cabin is laid out, is slightly elevated at the front tip so as to impart a sufficient height to the cockpit, this upper floor being able to terminate, at the front tip, with an upward-sloping portion.

In a preferred embodiment, the pressurized front space of the lower level comprises, between the resistant structure separating the hold and the cockpit, at least one area forming a personal space for the crew.

In addition, the pressurized front space also can comprise, behind the personal space for the crew, a technical area for electronic cabinets and various pieces of control equipment.

Moreover, one embodiment provides that the front pressurized space communicates directly with the outside through at least one main access door positioned at the level of the lower floor and opening either directly into the cockpit or into a personal space laid out behind the latter.

This personal space advantageously comprises a central aisle for access to the technical area, running between two rest lounges for the crew at the level of which the fuselage can be provided with windows.

Furthermore, the passenger cabin that extends over the entire length of the main deck can comprise, at the front of the fuselage, a pointed portion extending above the cockpit and at the level of which the fuselage is provided with a row of windows forming a panoramic window wall.

Advantageously, this pointed portion of the passenger cabin is equipped, at its front end, with two armchairs in front of which is placed a piece of equipment suggesting the configuration of a cockpit, provided with screens for display of aircraft flight information.

Other features and other advantages of the invention will become apparent in the following description of a specific embodiment, described by way of example with reference to the attached drawings.

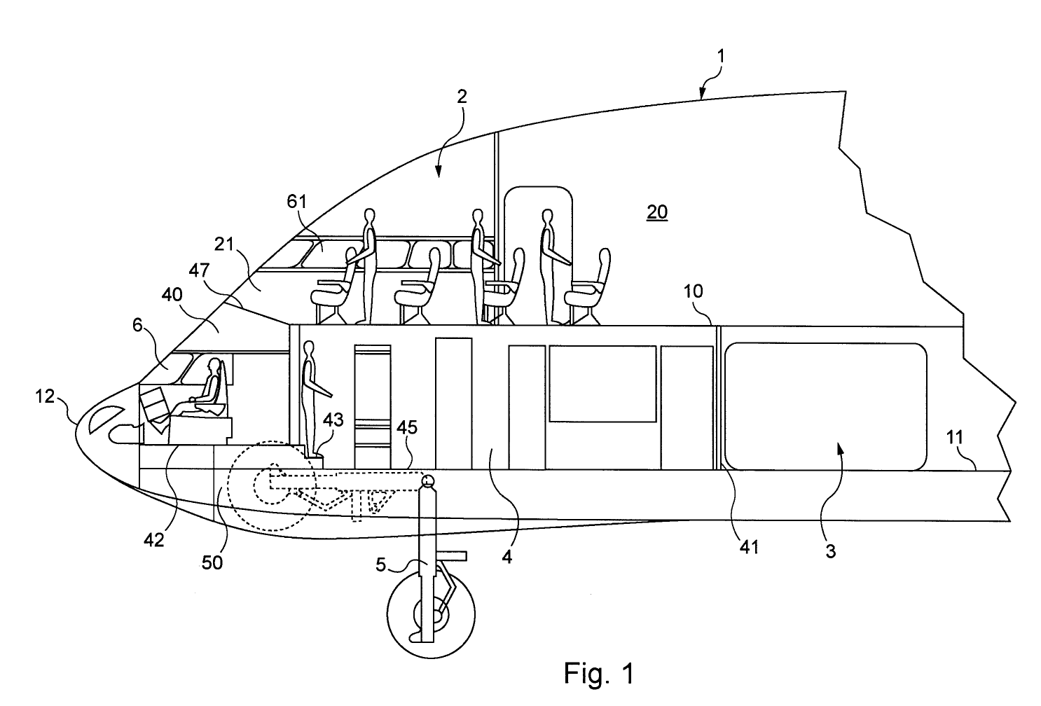

FIG. 1 is a view, in longitudinal section, of the front tip of an aircraft set up according to the invention,

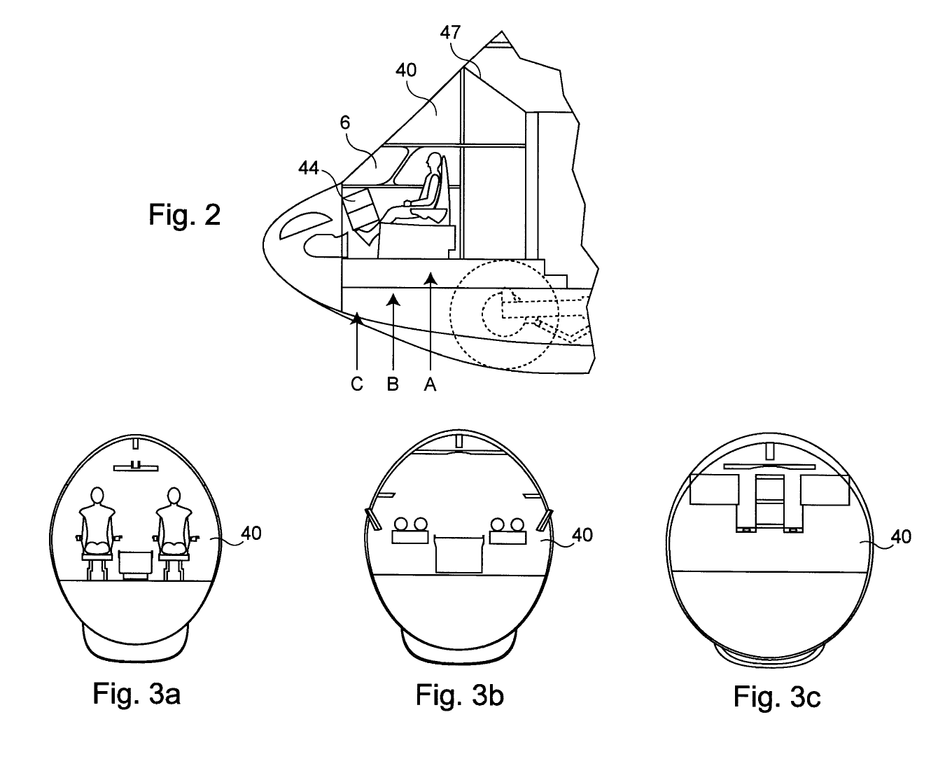

FIG. 2 is a detailed view of the cockpit, on an enlarged scale,

FIGS. 3a, 3b, 3c are views of the cockpit in cross section, according to sections A, B, C of FIG. 2, respectively,

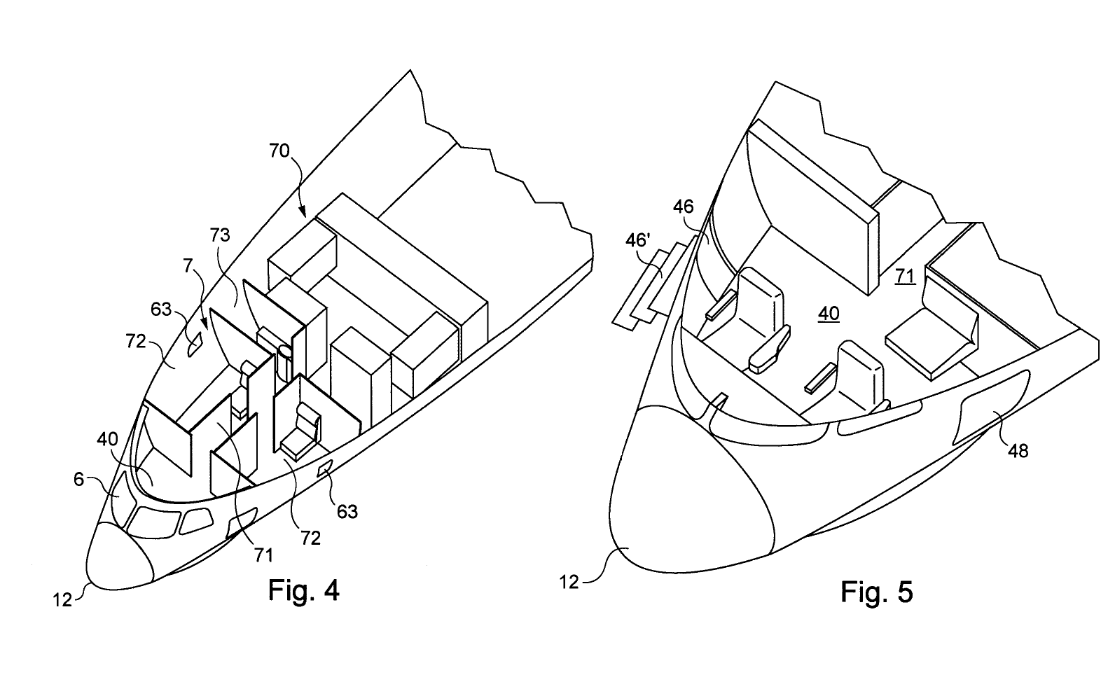

FIG. 4 is a perspective view from above of the pressurized lower space,

FIG. 5 is a detailed, perspective view of the cockpit,

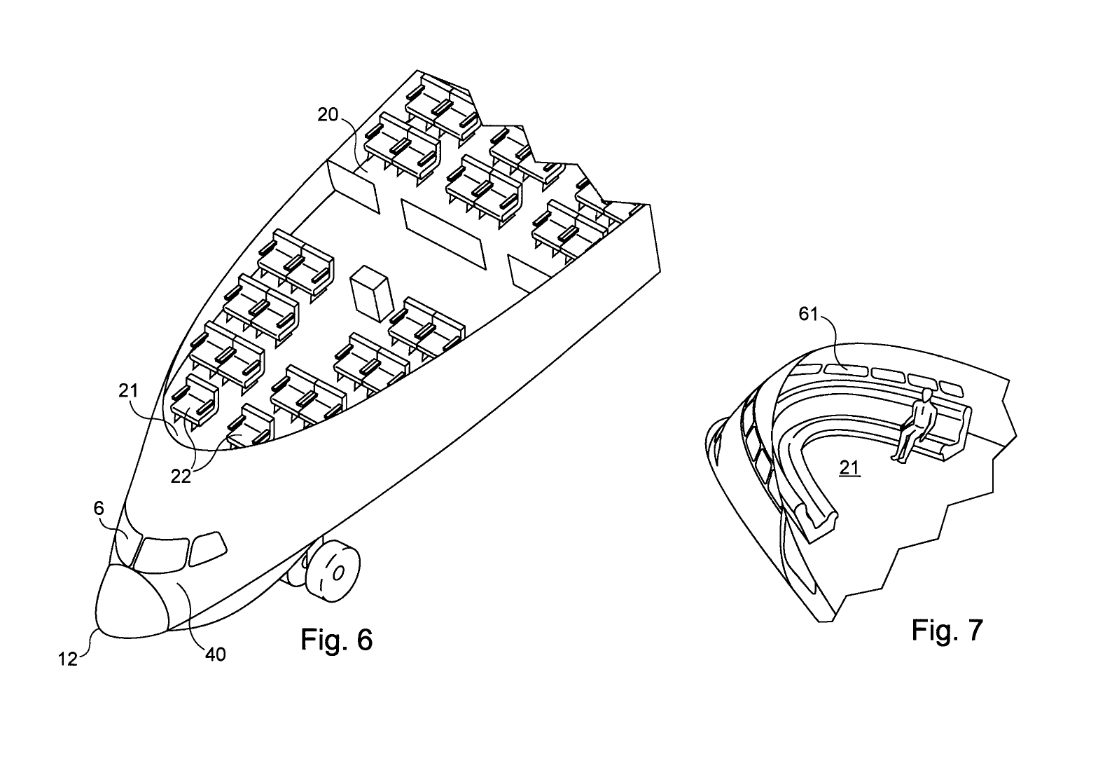

FIG. 6 is a perspective view of the front end of the passenger cabin, and

FIG. 7 is a perspective view of a lounge laid out at the front of the passenger cabin.

FIG. 1 shows, in longitudinal section, the front tip of the fuselage 1 of an aircraft for transport of passengers. As is customary, this fuselage is divided into two superposed levels by a floor 10 forming a main deck, respectively an upper level 2 and a lower level 3.

Usually, the upper level 2 that is pressurized and air-conditioned comprises, over its greater length, a passenger cabin 20 and, at the front, a cockpit, while the lower level 3, below the main deck 10, forms a hold for baggage and various loads transported.

On the other hand, according to the invention, the front of the upper level 2 contains only the passenger cabin 20 that extends over the entire length of the main deck 10, and the lower level 3 comprises, at the front, an additional pressurized space 4 laid out below the main deck 10 between the nose 12 of the aircraft that often forms a radome, and a transverse wall 41 having a structure sufficiently resistant to form an “anti-crash” wall withstanding possible impacts coming from the hold 3.

In the preferred embodiment illustrated in the Figures, the main deck 10 is slightly elevated and the main frame of the fuselage structure is larger than that of an aircraft of standard contour, so that the overall height H of the fuselage makes it possible to arrange the passenger cabin 20 above the additional pressurized space 4 in which the cockpit 40 is positioned, at the level of the hold 3.

In particularly advantageous manner, the additional pressurized space 4 has a floor 45 positioned in the extension of the floor 11 of the hold 3, but its front end 42, at the tip of the aircraft, is slightly elevated, for example by the height of two steps 43, so as to form a housing 50 for the at least partial storage of a front landing gear 5 in withdrawn position.

The floor 42 of the cockpit 40 that is laid out in the tip of the aircraft, at the front of the pressurized space 4, indeed should be positioned at an appropriate level so that, as shown by FIGS. 3a, 3b, 3c corresponding to cross sections according to planes A, B, C of FIG. 2, the cockpit has, at its various levels, taking into account the pointed shape of the fuselage, a sufficient width for positioning two seats for the pilot and the co-pilot facing the on-board controls 44. The cockpit therefore has a relatively low height but nonetheless can have a space similar to that of an aircraft of standard contour.

Furthermore, the cockpit 40 can communicate directly with the outside through a door 46 (FIG. 5) possibly combined with stairs 46′ and also comprises an emergency exit 47 toward the top, opening into the passenger cabin 20 (FIGS. 1 and 2). A left side emergency exit 48 (FIG. 5) also is provided. It makes it possible for the cockpit to communicate with the outside of the aircraft.

Toward the front, of course, the cockpit is provided with windows 6 affording a panoramic view to the pilots.

Taking into account the large main frame of the fuselage at the rear of the cockpit and the need to achieve a good compromise between the cockpit space and the shape of the front tip with both permitting side access, rear side visibility may be considered insufficient. This drawback can be compensated for by the use of video cameras trained on the sides toward the back, in particular for night vision.

In particularly advantageous manner, the additional pressurized space 4 positioned, according to the invention, at the level of the hold 3 and separated from the latter by the resistant transverse wall 41 comprises, between this transverse wall 41 and the cockpit 40, a crew area 7 forming a personal space and a technical area 70 (FIG. 4).

The crew area 7 can comprise, on both sides of a central aisle 71, two lounges possibly equipped with berths, and bathroom installations 73. The front portion of the passenger cabin 20 extends, according to the invention, to above the cockpit 40 and therefore below the crew area 7.

It is to be noted that these rest areas for the crew can be equipped with windows 63 (FIG. 4), which offers a comfort advantage in comparison with the arrangements used until now.

The technical area 70 makes it possible to position all of the pieces of control equipment, in particular the electronic cabinets, as well as the various storage units, in a zone accessible via the aisle 71.

Thus the unit formed by the cockpit 40, the crew personal space 7 and the technical area 70 where a considerable portion of the airplane controls are grouped together, is consolidated in the pressurized space 4 that can be completely isolated from the rest of the aircraft and, in particular, from the passenger cabin 20. The air-conditioning and pressurization of the passenger cabin 20 and the crew space 4 can be implemented through circuits controlled separately, which makes it possible to provide better conditions of flight safety in the event of an act of skyjacking.

Communication between the passenger cabin 20 and the crew space 4 takes place, as was indicated, through an emergency exit 47 in the front portion of the upper floor 10 running below the additional pressurized space. This exit can be provided with a reinforced door that cannot be opened from the passenger cabin 20.

The front portion 21 of the passenger cabin 20 that extends over the entire length of the main deck 10, to above the cockpit 4, can be provided with an upper row of windows 61 forming a panoramic window wall.

This front portion 21 then can be equipped, for example, with first-class seats, as illustrated in FIG. 6, or else form a lounge, as indicated in FIG. 7.

The front tip of this zone 21 advantageously can be equipped with two armchairs 22 arranged in a manner similar to the seats for the pilot and co-pilot, in front of which there is positioned a piece of equipment suggesting the configuration of a cockpit and provided, for example, with screens for the display of aircraft flight information.

Furthermore, the floor 10 of the passenger cabin 20 can be raised, at its front end located in front of the first armchairs 22, with an upward-sloping portion making it possible to increase the headroom above the cockpit in order to facilitate access to the pilots' armchairs. This corresponds to the location selected for arranging a reinforced hatchway forming the emergency exit 47.

The invention, of course, is not limited to the details of the embodiment that has just been described by way of mere example, the particular configuration of the aircraft according to the invention allowing for numerous variations, depending on the equipment selected.

1. Aircraft for transport of passengers comprising a cockpit (40) and a cabin (20) for passengers inside a fuselage (1) divided into two levels by a floor (10) forming a main deck, respectively an upper pressurized level (2) and a lower level forming a hold (3) for the loads transported,
characterized by the fact that the cockpit (40) is positioned in a pressurized space (4) laid out in front of the hold (3) and at the same level as the latter, below the floor (10) of the passenger cabin that extends over the entire length of the fuselage (1), the said front pressurized space (4) being closed toward the rear by a structure (41) withstanding the possible impacts coming from the hold (3).

2. Aircraft according to claim 1, characterized by the fact that, the hold (3) being laid out on a lower floor (11), the front portion of the latter forms the floor (45) of the cockpit (40).

3. Aircraft according to claim 2, characterized by the fact that the front end of the lower floor (11) is slightly raised so as to impart a sufficient width to the cockpit, taking into account the pointed shape of the fuselage (1).

4. Aircraft according to one of the preceding claims, characterized by the fact that the upper floor (10) on which the passenger cabin (20) is laid out is slightly elevated at its front end, so as to impart a sufficient height to the cockpit (40).

5. Aircraft according to claim 4, characterized by the fact that the upper floor (10) bearing the passenger cabin (20) terminates, at the front tip, with an upward-sloping portion.

6. Aircraft according to claim 5, characterized by the fact that the sloping portion, at the front tip of the upper floor (10), is provided with a hatchway forming an emergency exit (47).

7. Aircraft according to claim 3, characterized by the fact that the elevated front portion (42) of the floor (45) of the cockpit (40) defines a storage compartment (50) for the front landing gear (5), in withdrawn position.

8. Aircraft according to one of the preceding claims, characterized by the fact that the front pressurized space (4) of the lower level (3) comprises, between the resistant structure (41) separating the hold (3) and the cockpit (40), at least one area (7) forming a personal space for the crew.

9. Aircraft according to claim 8, characterized by the fact that the front pressurized space (4) of the lower level (3) comprises, between the personal space (7) for the crew and the separating resistant structure (41), a technical area (70) for electronic cabinets and various pieces of control equipment.

10. Aircraft according to one of the preceding claims, characterized by the fact that the front pressurized space (4) of the lower level (3) communicates with the outside through at least one main access door (45) positioned at the level of the lower floor (11) and opening either directly into the cockpit (40) or into a personal space (7) laid out behind the latter.

11. Aircraft according to claim 10, characterized by the fact that the area forming the personal space (7) comprises a central aisle (71) for access to the technical area (70), running between two modules (72) forming rest areas for the crew, at the level of which the fuselage is provided with windows (63).

12. Aircraft according to one of the preceding claims, characterized by the fact that the passenger cabin (20) comprises, at the front of the fuselage (1), a pointed portion extending above the cockpit (40) and at the level of which the fuselage (1) is provided with a row of windows (61) forming a panoramic window wall.

13. Aircraft according to claim 12, characterized by the fact that the pointed portion of the passenger cabin (20) is equipped, at its front end, with two armchairs (22) in front of which there is positioned a piece of equipment suggesting the configuration of a cockpit, provided with screens for the display of aircraft flight information.

14. Aircraft according to preceding claims, characterized by the fact that the cockpit (20) is equipped, on each side, with video cameras trained toward the rear in order to increase the field of vision of the pilots.
